(19) United States
(12) Patent Application Publication
(10) Pub. No.: US 2015/0254912 A1
(43) Pub. Date: Sep. 10, 2015

(54) DNA based security

(71) Applicant: Adamov Ben-Zvi Technologies LTD., Sde Warburg (IL)

(72) Inventor: David Meir Weisman, Kfar Saba (IL)

(73) Assignee: Adamov Ben-Zvi Technologies LTD., Sde Warburg (IL)

(21) Appl. No.: 14/195,894

(22) Filed: Mar. 4, 2014

(51) Int. Cl. G07C 9/00; G06Q 50/26

(52) U.S. Cl. CPC G07C 9/00087; G06Q 50/265

(57) ABSTRACT

A method for Deoxyribonucleic acid (DNA) based security, the method may include obtaining, by a first computerized entity, unique DNA information of a person that is unique to the person; generating authentication information in response to the unique DNA information; and participating, by the first computerized entity, in an authentication process for conforming an identity of the person, wherein the participating involves utilizing the authentication information.

### BACKGROUND

In our digital world today we need to authenticate ourselves before we can get access to different data or different services. These authentications today involve different schemes, means and methods including biometric methods.

Additional problem in the today biometric verification system is the accuracy of the biometrics reference template slowly decays over time as the human body evolves. This means that the stored biometric reference template will periodically need to be refreshed.

### SUMMARY

There may be provided a method of a method for Deoxyribonucleic acid (DNA) based security, the method may include obtaining, by a first computerized entity, unique DNA information of a person that is unique to the person; generating authentication information in response to the unique DNA information; and participating, by the first computerized entity, in an authentication process for conforming an identity of the person, wherein the participating involves utilizing the authentication information.

The method may include calculating a DNA based token from the unique DNA information; and generating, by the first computerized entity, at least one DNA based key out of a DNA based encryption key and a DNA based authentication key based on the DNA based token.

The method may include preventing, by the first computerized entity, an access of an entity outside the first computerized entity, to the at least one DNA based key.

The method may include generating the at least one key in response to the DNA based token and at least one other information unit.

The at least one other information unit is selected out of a location information unit, a non-DNA biometric information unit, a non-DNA information sequence identifier, and a one-time non-DNA password.

The method may include calculating a first and a second DNA based tokens from the unique DNA information; associating the first DNA based token with a first application; and associating the second DNA based token with a second application.

The participating in the authentication process may include participating in multiple spaced apart authentication sessions.

The participating in at least one authentication session of the multiple spaced apart authentication sessions may include sending, by the first computerized entity to a second computerized entity, an encrypted DNA based token that is generated by encrypting a DNA based token generated in response to the unique DNA information of the person.

The method may include encrypting the DNA based token to provide the encrypted DNA based token using a key calculated in response to the unique DNA information.

The participating in at least one authentication session of the multiple spaced apart authentication sessions may include sending samples of biometric information related to the person, the biometric information is non-DNA information.

The method may include selecting non-DNA biometric information of the person to provide selected non-DNA biometric samples, wherein the selecting is responsive to the unique DNA information; wherein the selected non-DNA forms at least a portion of the authentication information.

The obtaining may include extracting DNA information from at least one cell of the person; and extracting the unique DNA information from the DNA information.

The obtaining may include receiving DNA information that was extracted from at least one cell of the person; and extracting the unique DNA information from the DNA information.

There may be provided a non-transitory computer readable medium that stores instructions that once executed by a first computerized entity cause the first computerized entity to obtain unique DNA information of a person that is unique to the person; and participate in an authentication process for conforming an identity of the person, wherein the participating involves utilizing authentication information that is responsive to the unique DNA information.

There may be provided a computerized device that may include a memory module for storing unique Deoxyribonucleic acid (DNA) of a person; and a processor that is arranged to generate authentication information in response to the unique DNA information; and participate in an authentication process for conforming an identity of the person, wherein the participating involves utilizing the authentication information.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates data entities according to an embodiment of the invention;

FIG. 2A illustrates a method according to an embodiment of the invention;

FIG. 2B illustrates a stage of the method of FIG. 2A according to an embodiment of the invention;

FIG. 3 illustrates a method according to an embodiment of the invention;

FIG. 4A illustrates a method according to an embodiment of the invention;

FIG. 4B-4D illustrates a selection of non-DNA biometric information according to an embodiment of the invention;

FIG. 5 illustrates a method according to an embodiment of the invention; and

FIG. 6 illustrates a computerized device according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

In the following text “DNA” stands for Deoxyribonucleic acid.

According to various embodiments of the invention there are provided DNA based security methods, devices and non-transitory computer readable media.

The DNA based security may generate a private secret which can be used as a secret key for symmetric cryptographic algorithms (for example: DES, 3DES, AES, etc.) or and can be used as the input for the hash function for asymmetric cryptographic calculation. The DNA based security is dynamic and can be used for a variety of applications.

The DNA based security may include providing a continues secret generation process which can be used for continues authentication and continues cryptographic calculation. Unique DNA information can be generated and used and may be based on different areas in the DNA map which have a big variant (which are suitable for crypto calculation), this DNA based security data can be combine with any additional private information like PIN, Finger Print, Voice, Face, passphrase etc.

DNA based security may provide the best solution for combating identity theft by providing a unique digital representation of the real person which can't be reproduced without been identified. The unique DNA information can be split to multiple unique DNA information portions that can be used for different applications.

The DNA based security patent can be combined with biological sensors (like: skin conductivity, etc.) and with environmental sensors like GPS to provide additional information units that may be used during the authentication process, in addition to the unique DNA information portions.

The DNA based security may include hashing (for example by applying a hash function like SHA-256, SHA-512, with salt or HMAC, HMAC-SHA-1, RSA-SHA1, PBKDF2, etc.) unique DNA information portions. DNA based keys may be generated in response to unique DNA information portions and zero or more other information units such as location information units, timing information units, additional non-DNA information units, one time code, one time password, input provided from a smart card, a secure element, a token generator, etc. This information may be used to generate DNA based keys by applying DUKPT (Derived Unique Key Per Transaction, like ANSI X9.24, PBKDF2, etc.) or other methods.

A first computerized entity may be provided and may be a tamper resistant device that may maintain a predefined mathematical function module (such as a transaction counter) which is autonomous and not accessed from outside. In a case of a counter—an incremental or decremented value of the counter (or appliance of another predefined mathematical function) may provide values that are used during one or more authentication sessions. The first computerized entity and a second computerized entity that will participate in the authentication process will operate according to one or more rules that are that are to both computerized entities.

The DNA based security may allow a first and second to exchange information when the exchange of information is conditioned by a successful authentication of the certain person. Non-limiting of first and second computerized entities include mobile phones, laptop computers, desk top computers, tablet computers, game consoles, servers, storage systems, wearable computers, smart television. The first and second computerized entities may communicate over wired channels, wireless or a combination thereof. The first and second computerized entities may be connected to each other (for example one being plugged in the second), or not.

The first computerized entity may extract the unique DNA information.

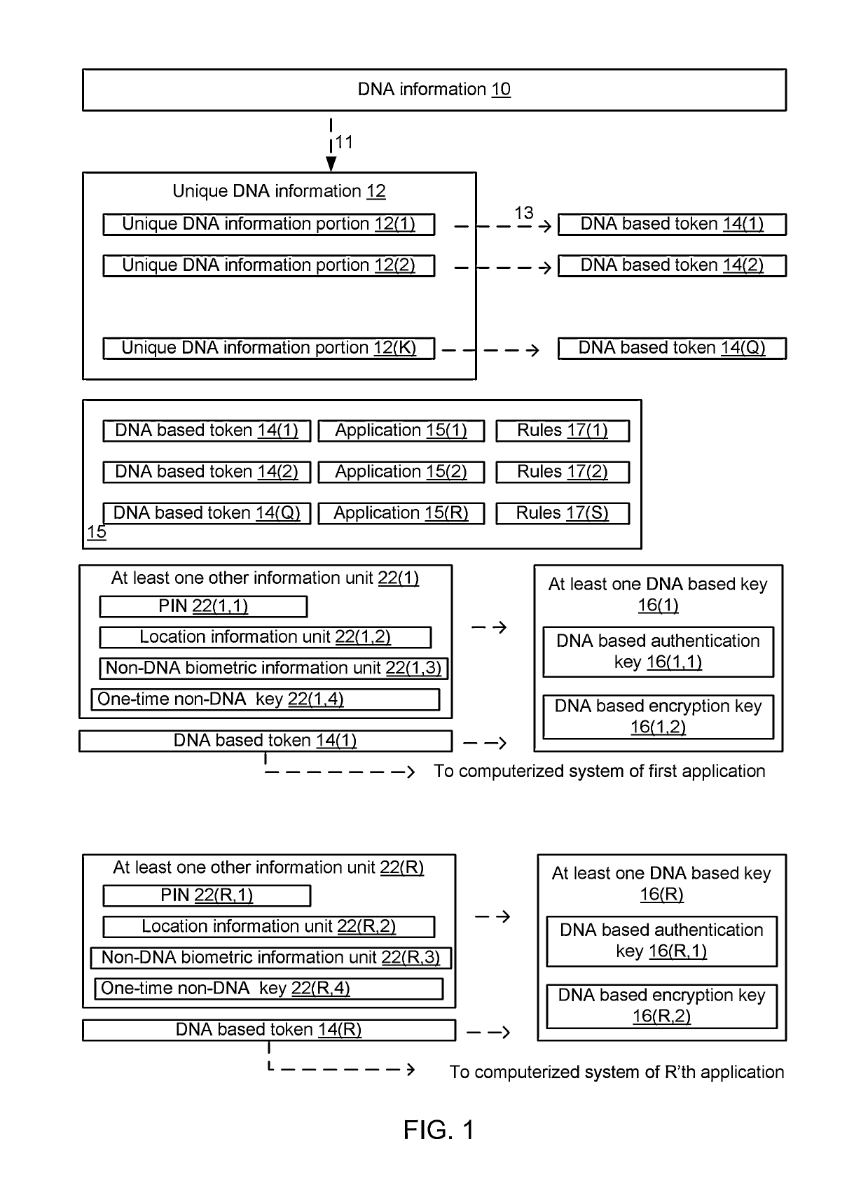

FIG. 1 illustrates various data entities according to various embodiments of the invention.

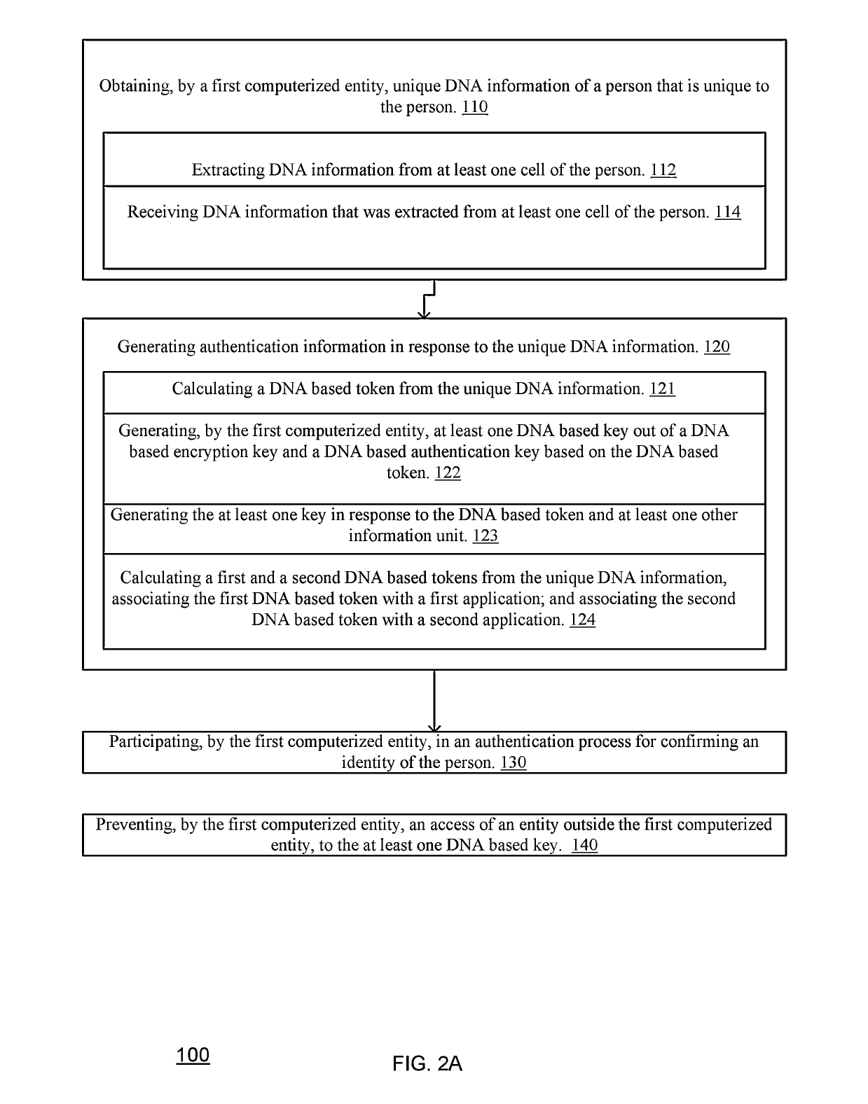

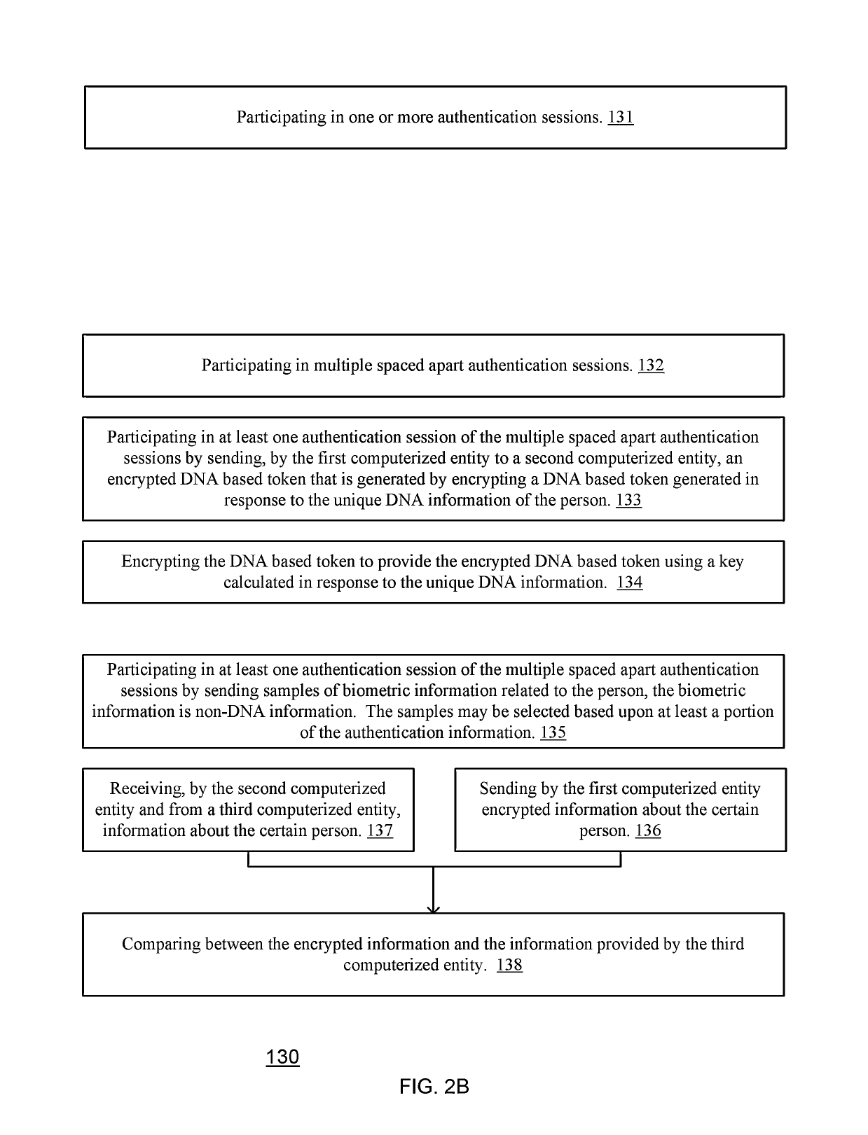

The manner in which the data entities are used is further illustrated in other figures such as FIGS. 2A-2B, 3 and 4.

The data entities of FIG. 1 include:
a. DNA information 10. It is assumed that the DNA information 10 is of a certain person. It is extracted from one or more cells of the certain person.
b. Unique DNA information 12. The unique DNA information 12 is unique to the certain person. DNA information of other persons is not expected not to include the unique DNA information of the certain person.
   i. The unique DNA information can be extracted using paternity test technology.
   ii. Unique DNA information can be found, for example, in regions with high content of single nucleotide polymorphism (SNP) sites. The extraction may include sequencing of multiple sites of the DNA sequence to create the unique DNA information. Any process for extracting unique DNA can be applied.
   iii. The unique DNA information may include some of the non-variable nucleotides in various areas of the DNA sequence. For example—if SNP at a given position is X, then the non-variable nucleotide at another given position would be given a value A, and so on if SNP is Y the non-SNP would be B etc.
   iv. The unique DNA information 12 may include multiple (K) portions—12(1)-12(K), K being a positive integer. Each unique DNA information portion is expected to be unique to the certain person. The unique DNA information 12 may be extracted (dashed arrow 11) from the DNA information 12 of the certain person.
c. DNA based tokens 14(1)-14(Q). Each DNA based token can be generated by processing one or more unique DNA information portion. It is assumed, for simplicity of explanation, that one DNA based token is generated by hashing a single unique DNA information portion. The hashing is an example of an encryption process that can be used for generating the DNA based token.
d. A mapping data structure 15 that maps the Q DNA based tokens 14(1)-14(Q) to multiple (R) applications 15(1)-15(R), wherein R may equal Q (one DNA based token per application) or may differ from R. The mapping data structure 15 may also include rules 17(1)-17(S) that may indicate how to apply an authentication process. A rule can indicate, for example, that a unique DNA information portion should include information about the biological sex of the certain person. Yet another rule can indicate whether to utilize, in the generation of a DNA based key, one or more other information units (that differ from the DNA based token), and the like.
e. At least one other information unit (such as 22(1) and 22(R)), that may include (per application) at least one out of location information unit (such as 22(1,2) and 22(R,2)), a non-DNA information sequence identifier (such as Personal Identification Number (PIN) 22(1,1) and 22(R,1), non-DNA biometric information unit (such as 22(1,3) and 22(R,3)), and one-time non-DNA key (such as 22(1,4) and 22(R,4)). The at least one other information unit, in addition to a DNA based token, can be processed to generate at least one DNA based keys (such as 16(1) and 15(R).
f. At least one DNA based key (such as 16(1,1), 16(1,2), 16(R,1) and 16(R,2)). FIG. 1 illustrates DNA based encryption key 16(1,2) and DNA based authentication key 16(1,1) related to a first application, as well as DNA based encryption key 16(R,2) and DNA based authentication key 16(R,1) related to a R'th application. The DNA based keys can include additional keys, other keys, and the like.

FIG. 2A illustrates method 100 according to an embodiment of the invention. FIG. 2B illustrates stage 130 of method 100 according to an embodiment of the invention.

Method 100 may start by stage 110 of obtaining, by a first computerized entity, unique DNA information of a person that is unique to the person.

Stage 110 may include extracting (112) DNA information from at least one cell of the person or receiving (114) DNA information that was extracted from at least one cell of the person.

Stage 110 may be followed by stage 120 of generating authentication information in response to the unique DNA information. Stage 120 may include generating authentication information that may include, for example, one or more DNA based tokens (12(1)-12(K)), one or more DNA based keys such as DNA based authentication keys 16(1,1) and 16(1,R) and/or DNA based encryption key 16(1,2) and 16(R,2).

Stage 120 may include at least one of the following:
a. Calculating (121) a DNA based token from the unique DNA information.
b. Generating (122), by the first computerized entity, at least one DNA based key out of a DNA based encryption key and a DNA based authentication key based on the DNA based token.
c. Generating (123) the at least one key in response to the DNA based token and at least one other information unit.
d. Calculating (124) a first and a second DNA based tokens from the unique DNA information, associating the first DNA based token with a first application; and associating the second DNA based token with a second application.

Stage 120 may be followed by stage 130 of participating, by the first computerized entity, in an authentication process for confirming an identity of the person. The participating may involve utilizing the authentication information generated during stage 120.

Stage 130 may include at least one of the following (see FIG. 2B):
a. Participating (131) in one or more authentication sessions.
b. Participating (132) in multiple spaced apart authentication sessions. The multiple spaced apart authentication processes may be form a so-called continuous authentication, may be triggered in response to events (such as a communication failure, any event that may indicate of a security breach) according to a predetermined schedule or a combination thereof.
c. Participating in at least one authentication session (133) of the multiple spaced apart authentication sessions by sending, by the first computerized entity to a second computerized entity, an encrypted DNA based token that is generated by encrypting a DNA based token generated in response to the unique DNA information of the person.
d. Encrypting (134) the DNA based token to provide the encrypted DNA based token using a key (such as a DNA based encryption key) calculated in response to the unique DNA information. The encrypted DNA based token can be sent to the computerized server than may decrypt it (using a DNA based token), and determine whether the authentication failed or succeeded.
e. Participating (135) in at least one authentication session of the multiple spaced apart authentication sessions by sending samples of biometric information related to the person, the biometric information is non-DNA information. The samples may be selected based upon at least a portion of the authentication information.
f. Sending (136) by the first computerized entity encrypted information about the certain person (such information about the location of the certain person, an activity of the certain person).
g. Receiving (137), by the second computerized entity and from a third computerized entity, information about the certain person. The third computerized entity differs from the first computerized entity (camera, ATM machine).
h. Comparing (138) between the encrypted information and the information provided by the third computerized entity.

Method 100 may also include stage 140 preventing, by the first computerized entity, an access of an entity outside the first computerized entity, to the at least one DNA based key. Stage 140 may be executed in parallel to stages 110, 120 and 130.

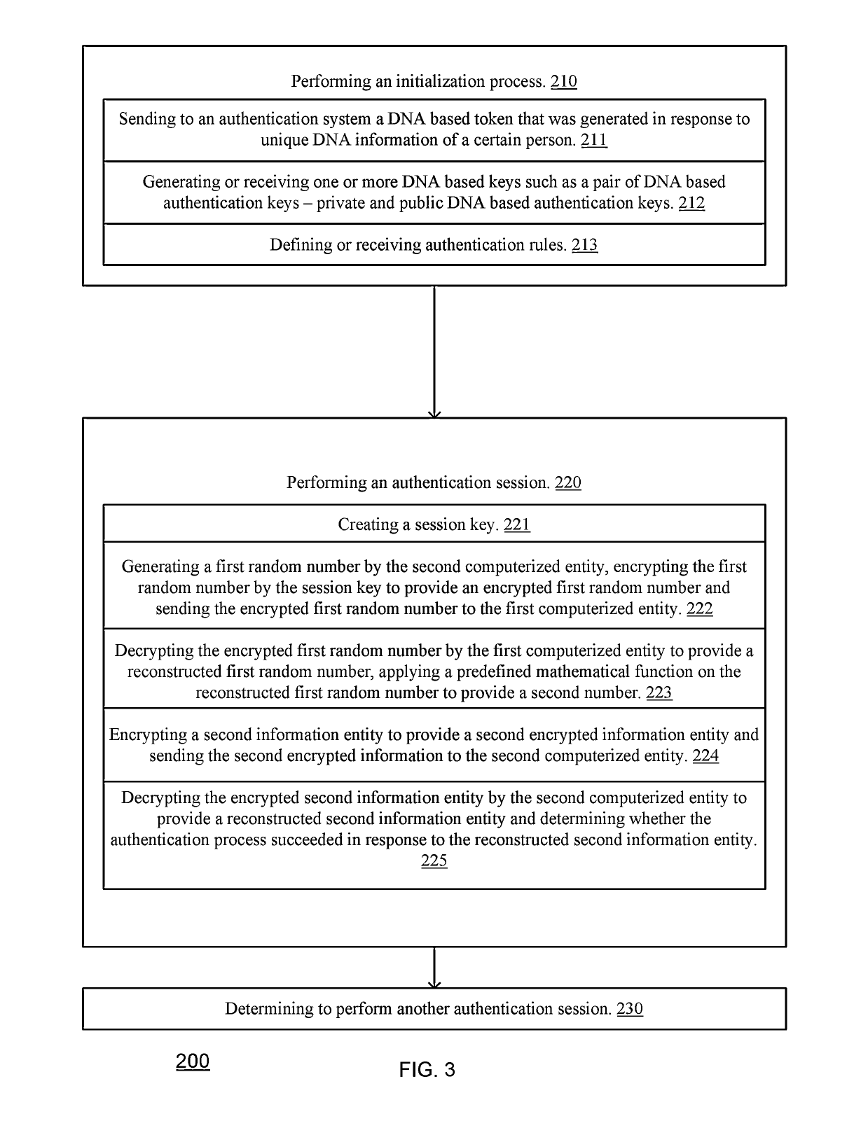

FIG. 3 illustrates method 200 for DNA based authentication according to an embodiment of the invention.

Method 200 may start by stage 210 of performing an initialization process.

The initialization process may include at least one out of:
a. Sending (211) to an authentication system a DNA based token that was generated in response to unique DNA information of a certain person.
b. Generating (212) or receiving one or more DNA based keys such as a pair of DNA based authentication keys—private and public DNA based authentication keys.
c. Defining or receiving (213) authentication rules.

Stage 210 may be followed by stage 220 of performing an authentication session.

Stage 220 may include:
a. Creating (221) a session key (for example using a ECDH protocol). This may be a symmetric key.
b. Generating (222) a first random number by the second computerized entity, encrypting the first random number by the session key to provide an encrypted first random number and sending the encrypted first random number to the first computerized entity.
c. Decrypting (223) the encrypted first random number by the first computerized entity to provide a reconstructed first random number, applying a predefined mathematical function (Defined by the authentication rules) on the reconstructed first random number to provide a second number.
d. Encrypting (224) a second information entity to provide a second encrypted information entity and sending the second encrypted information to the second computerized entity. The second information entity may be the second number. Alternatively, the second information may include the second number and the DNA based token.
e. Decrypting (225) the encrypted second information entity by the second computerized entity to provide a reconstructed second information entity and determining whether the authentication process succeeded in response to the reconstructed second information entity. For example—if the second information entity is the second number than determining that the authentication succeeded if the applying the predefined mathematical function on the first random number results in the second number. Yet for another example—if the second information entity includes the DNA based token then comparing the DNA based token previously provided (during stage 210) and the DNA based token from the reconstructed second information entity.

Stage 220 may be followed by stage 230 of determining to perform another authentication session and jumping to stage 220.

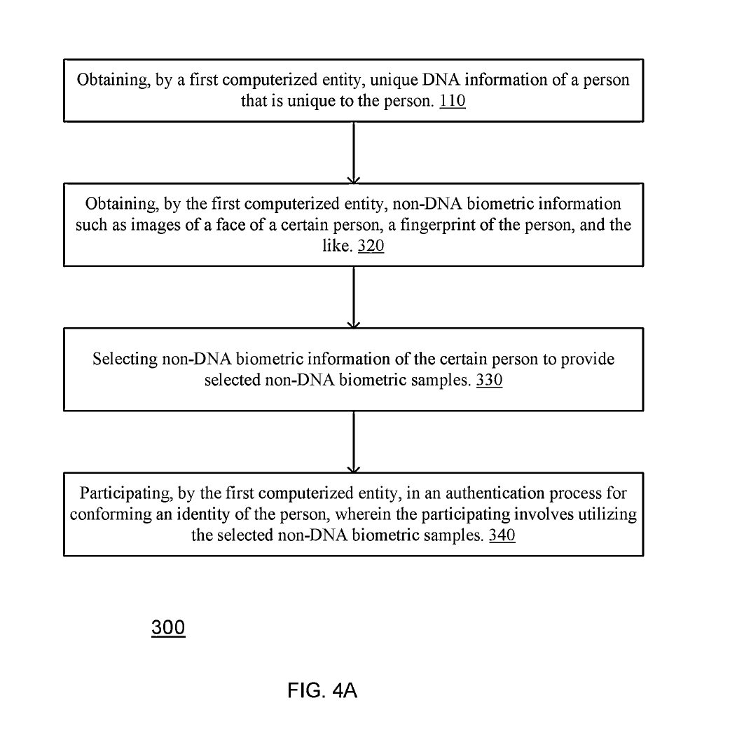

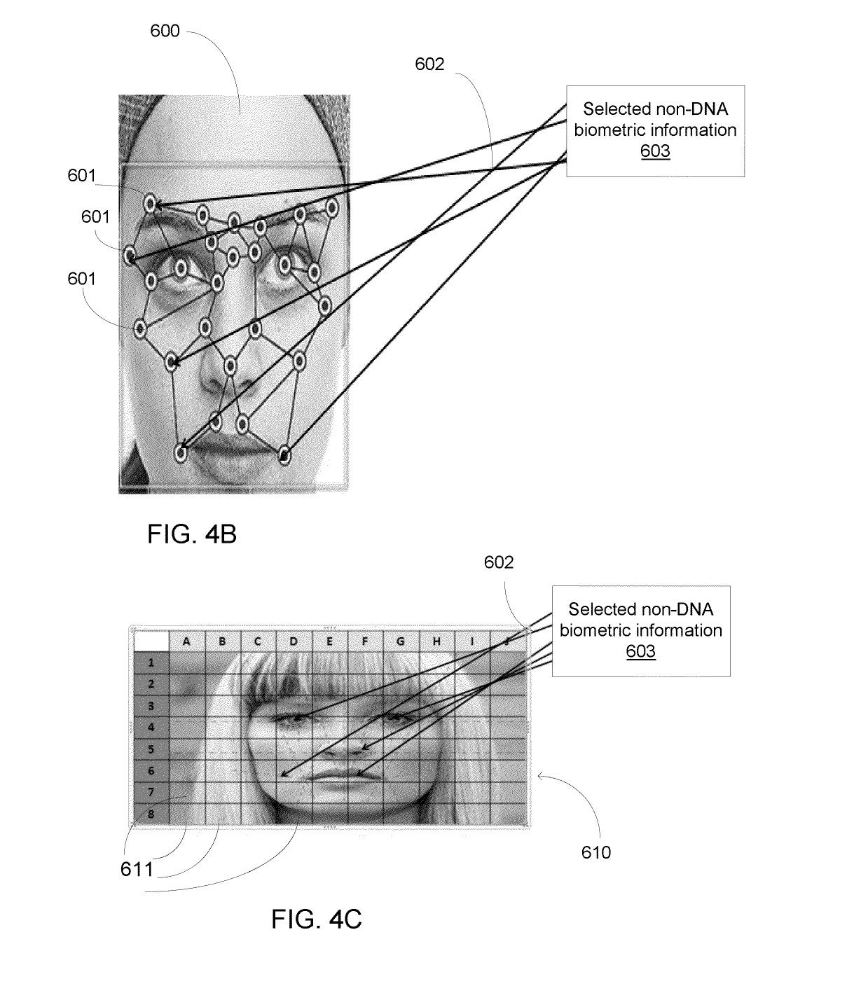

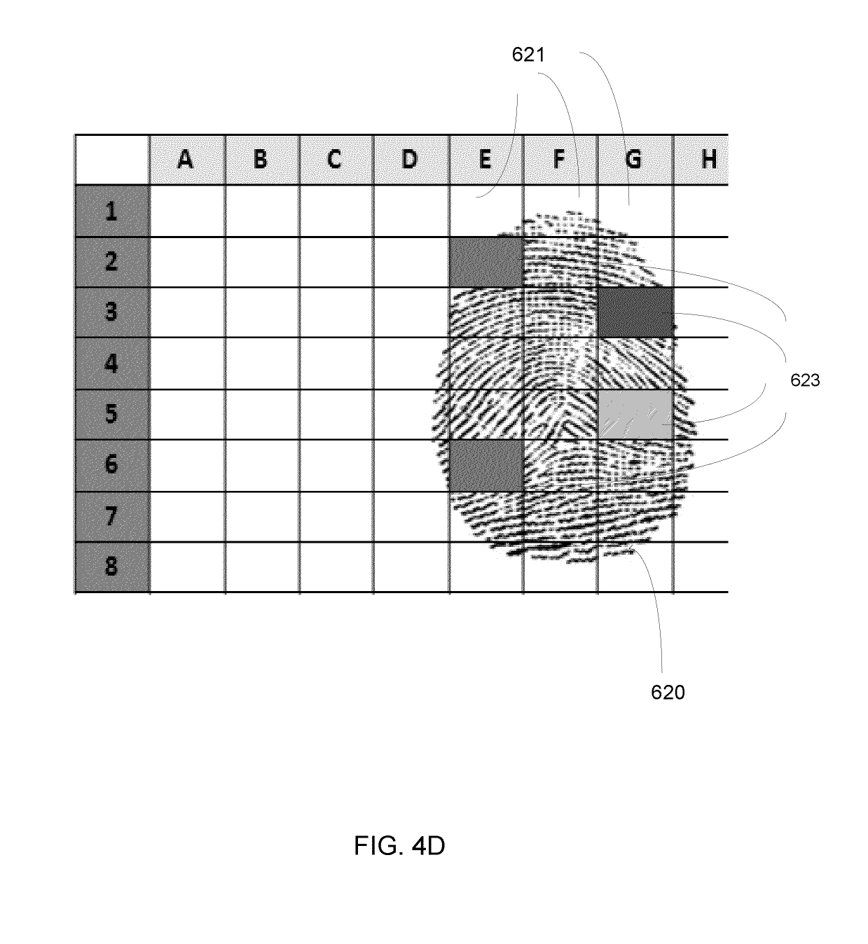

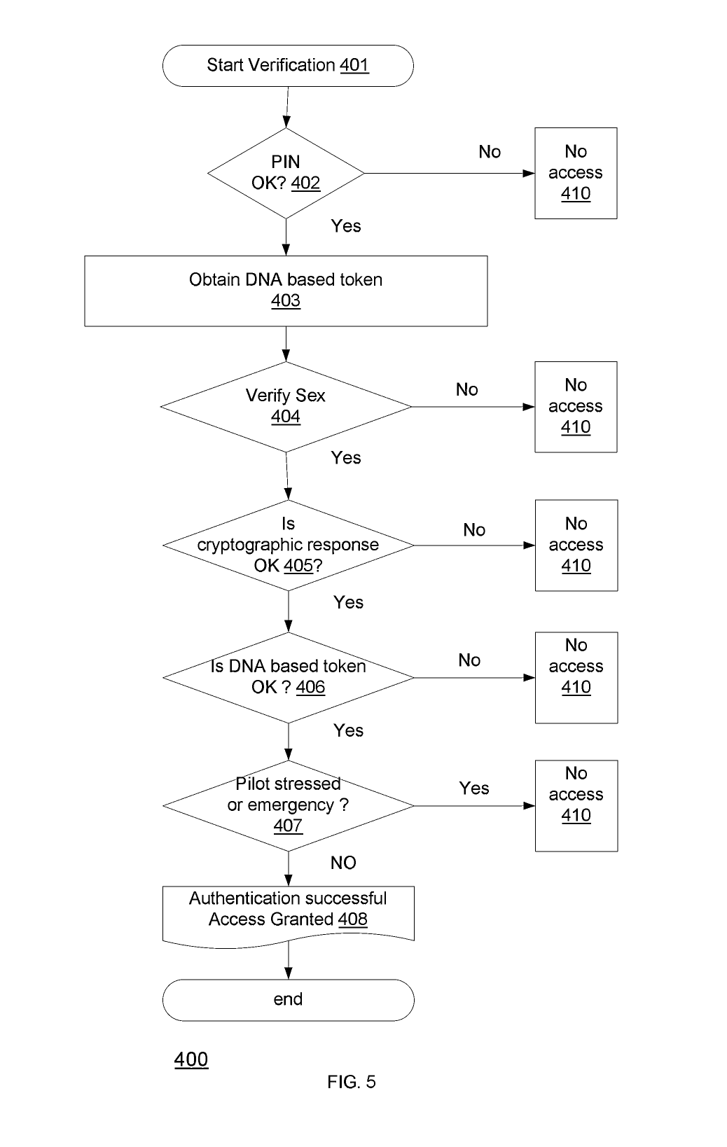

FIG. 4A illustrates method 300 according to an embodiment of the invention.

Method 300 may start by stage 110 of obtaining, by a first computerized entity, unique DNA information of a person that is unique to the person.

Stage 110 may be followed by stage 320 of obtaining, by the first computerized entity, non-DNA biometric information such as images of a face of a certain person, a fingerprint of the person, and the like.

Stage 320 may be followed by stage 330 of selecting non-DNA biometric information (out of the non-DNA biometric information obtained during stage 120) of the certain person to provide selected non-DNA biometric samples. The selecting is responsive to the unique DNA information.

Stage 330 may be followed by stage 340 of participating, by the first computerized entity, in an authentication process for conforming an identity of the person, wherein the participating involves utilizing the selected non-DNA biometric samples.

FIGS. 4B, 4C and 4D illustrates the generation of selected non-DNA biometric samples according to various embodiments of the invention.

In FIG. 4B a selection process (for example a mask) that is responsive to the unique DNA information image is used to select (represented by arrows 602) pixels (or rounded areas) 601 of an image 600 of a face of a person to provide selected non-DNA biometric samples 603.

In FIG. 4C a selection process (for example a mask) that is responsive to the unique DNA information image is used to select (represented by arrows 612) rectangular portions 611 of an image 610 of a face of a person to provide selected non-DNA biometric samples 613.

In FIG. 4D a selection process (for example a mask) that is responsive to the unique DNA information image is used to select (represented by non-white boxes) rectangular portions 621 of a fingerprint of a person to provide selected non-DNA biometric samples 623.

FIG. 5 illustrates method 400 for pilot authentication process according to an embodiment of the invention.

The process include, in addition to the DNA based authentication, an additional check for determining whether the pilot pressed a distress button or otherwise indicated that the plane is being hijacked. Only a successful authentication process will enable the pilot to control various elements of the plane.

In addition, the DDST can identify stress or/and distress situations of the DDST source. This can be used for example to identify hijack airplanes especially during pilot identification process.

Any combination of any the mentioned above methods may be provided.

Any authentication processes may further involve using a certification entity.

FIG. 5 illustrates a pilot authentication process 400 according to an embodiment of the invention.

The pilot authentication process 400 includes start stage (401), PIN check (402), obtain DNA based token (403), verify sex of pilot by comparing sex information embedded in the DNA based token and input from the pilot (404), check whether the cryptographic response is OK (405), check whether the DNA based token is OK (406), whether pilot indicated that he/she is stressed or that the airplane is hijacked (406). If all tests are Ok then the authentication process successfully ends (407)—else—the process fails (no access is granted to the pilot to a certain plane component or process—410).

This DNA based security can be used for security different clearance levels. i.e. different application can use different unique DNA information portions that may provide different security levels.

The first computerized entity may be arranged to ensure that unique DNA information cannot be accessed by any inside application or/and any outside application except a secure kernel itself. All the data stored by the secure kernel (inside the secure environment) should be encrypted via strong encryption algorithms like (AES-128 and above). A password or/and PIN is required to gain access to the specific DNA based security or/and the DNA based security HASH value.

The first computerized entity should support inherently code & data encryption (example of technologies which use this future today are: Smart Cards, Secure Elements, HSM, etc). This encryption should encrypt any user data and the entire device code & configurations.

The encryption algorithm may be AES (Advanced Encryption Standard) with a minimum key length of 128-bit and should offer the levels of security which are required by government and regulators in the area of Identification, healthcare and finance (for example: CC EAL 6+, FIPS 140-2 Level 3, EMVCo etc.). The encryption key, which is utilized, for the device encryption is generated from a user passphrase, the device should use a certified key-derivation algorithms such as PBKDF2 (Password Based Key Derivation Function 2).

The security level of the first computerized entity may fulfill the federal Data-At-Rest (DAR) & Data-In-Transit (DIT) requirements, in any case the device will never store the DNA based security or his derivative (for example HASH) in his NVM (None volatile memory like Flash, EEPROM, PROM etc).

The first computerized entity should be capable of establishing a secure channel for information exchange with external device(s) via contact or contactless interfaces (like: SWP, 7816, UART, RF, NFC, WiFi, etc.) to be able to do so the device should support the following secure protocols, IKE & IKEv2 (Internet Key Exchange), Triple DES (168 bit) encryption, AES (128 bit and above) encryption, NSA suite B Cryptography, Web Browser (HTTPS), IPSec VPN.

The first computerized entity may be capable of establishing multiple VPN connections, include support for RSA SecureID token and support for CAC (Common Access Card) for government use. In cases that the first computerized entity is a mobile device (like Smart Phone, Tablet, iPad, etc) it may comply to the US DoD Mobile OS Security Requirements Guide (like SP 800-53 etc.).

The first computerized entity may include a certified secure boot which ensures the secure kernel load via cryptographic signature and the system software include the OS and application with keys which the root of trust is verified by the device hardware. The root certificate will be trusted institute or Organization like Government, Bank, etc. The Device security technology should follow the DISA (Defense Information Systems Agency) agency which publishes security requirements guides to improve security information systems. The security of the first computerized entity should include state of the art protection against malware attacks and against hacking. The device should be out of any debug capability (i.e. No Hardware and No Software debug future include no JTAG etc.)

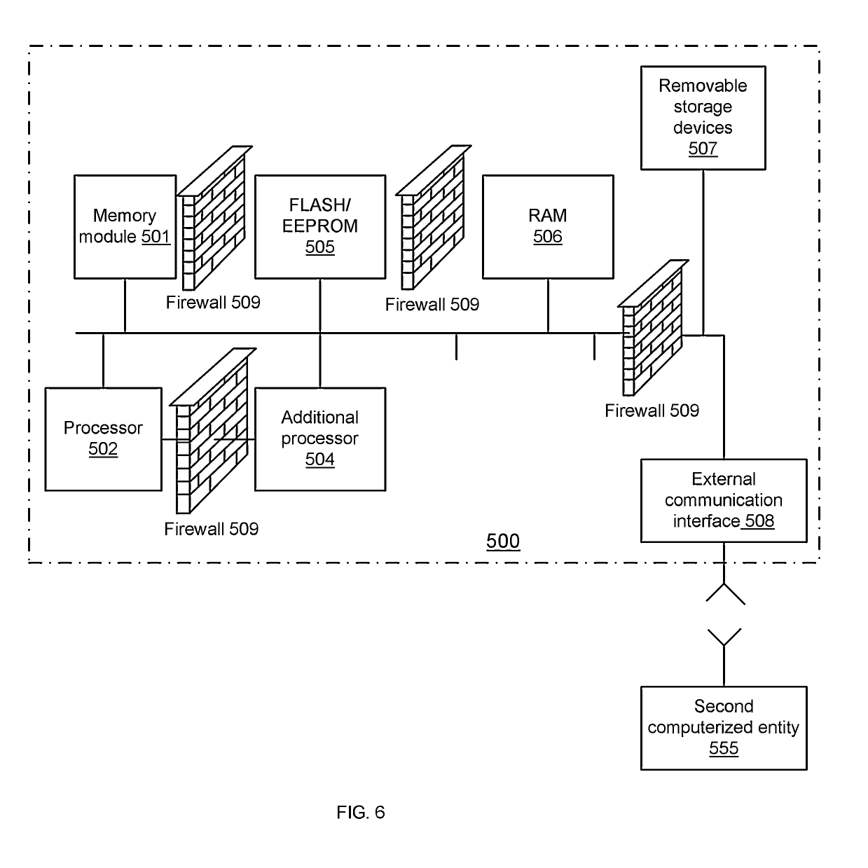

FIG. 6 illustrates an example of a first computerized entity 500 according to an embodiment of the invention.

The first computerized entity 500 may include secured components such as memory module 501 and processor 502—both entities are secured in the sense that the unique DNA information they store and/or process are not accessible by an entity outside the first computerized entity 500.

The first computerized entity 500 may also include a processor such as general purpose processor 504, FLASH/EPROM for storing boot code, RAM 506, removable storage devices such as SD cards, DVD players, disk on key devices and the like, and external communication interface 508.

FIG. 6 shows the first computerized entity 500 as being wirelessly coupled to second first computerized entity 555.

The first computerized entity may be arranged to ensure that unique DNA information cannot be accessed by any inside application or/and any outside application except a secure kernel itself. All the data stored by the secure kernel (inside the secure environment) should be encrypted via strong encryption algorithms like (AES-128 and above). A password or/and PIN is required to gain access to the specific DNA based security or/and the DNA based security HASH value.

The first computerized entity should support inherently code & data encryption (example of technologies which use this future today are: Smart Cards, Secure Elements, HSM, etc). This encryption should encrypt any user data and the entire device code & configurations.

The encryption algorithm may be AES (Advanced Encryption Standard) with a minimum key length of 128-bit and should offer the levels of security which are required by government and regulators in the area of Identification, healthcare and finance (for example: CC EAL 6+, FIPS 140-2 Level 3, EMVCo etc.). The encryption key, which is utilized, for the device encryption is generated from a user passphrase, the device should use a certified key-derivation algorithms such as PBKDF2 (Password Based Key Derivation Function 2).

The security level of the first computerized entity may fulfill the federal Data-At-Rest (DAR) & Data-In-Transit (DIT) requirements, in any case the device will never store the DNA based security or his derivative (for example HASH) in his NVM (None volatile memory like Flash, EEPROM, PROM etc).

The first computerized entity should be capable of establishing a secure channel for information exchange with external device(s) via contact or contactless interfaces (like: SWP, 7816, UART, RF, NFC, WiFi, etc.) to be able to do so the device should support the following secure protocols, IKE & IKEv2 (Internet Key Exchange), Triple DES (128 bit and above) encryption, AES (128 bit and above) encryption, NSA suite B Cryptography, Web Browser (HTTPS), IPSec VPN.

The first computerized entity may be capable of establishing multiple VPN connections, include support for RSA SecureID token and support for CAC (Common Access Card) for government use. In cases that the first computerized entity is a mobile device (like Smart Phone, Tablet, iPad, etc) it may comply to the US DoD Mobile OS Security Requirements Guide (like SP 800-53 etc.).

The first computerized entity may include a certified secure boot which ensures the secure kernel load via cryptographic signature and the system software include the OS and application with keys which the root of trust is verified by the device hardware. The root certificate will be trusted institute or Organization like Government, Bank, etc. The Device security technology should follow the DISA (Defense Information Systems Agency) agency which publishes security requirements guides to improve security information systems. The security of the first computerized entity should include state of the art protection against malware attacks and against hacking. The device should be out of any debug capability (i.e. No Hardware and No Software debug future include no JTAG etc.)

It is noted that the secure DNA is robust in the sense that the DNA information does not change over time—in contrary to other biometric features.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for Deoxyribonucleic acid (DNA) based security, the method comprises:
obtaining, by a first computerized entity, unique DNA information of a person that is unique to the person;
generating authentication information in response to the unique DNA information; and
participating, by the first computerized entity, in an authentication process for conforming an identity of the person, wherein the participating involves utilizing the authentication information.

2. The method according to claim 1 comprising:
calculating a DNA based token from the unique DNA information; and
generating, by the first computerized entity, at least one DNA based key out of a DNA based encryption key and a DNA based authentication key based on the DNA based token.

3. The method according to claim 2 comprising preventing, by the first computerized entity, an access of an entity outside the first computerized entity, to the at least one DNA based key.

4. The method according to claim 2 comprising generating the at least one key in response to the DNA based token and at least one other information unit.

5. The method according to claim 4 wherein the at least one other information unit is selected out of a location information unit, a non-DNA biometric information unit, a non-DNA information sequence identifier, and a one-time non-DNA password.

6. The method according to claim 1 comprising:
calculating a first and a second DNA based tokens from the unique DNA information;
associating the first DNA based token with a first application; and
associating the second DNA based token with a second application.

7. The method according to claim 1 wherein the participating in the authentication process comprises participating in multiple spaced apart authentication sessions.

8. The method according to claim 7, wherein a participating in at least one authentication session of the multiple spaced apart authentication sessions comprises sending, by the first computerized entity to a second computerized entity, an encrypted DNA based token that is generated by encrypting a DNA based token generated in response to the unique DNA information of the person.

9. The method according to claim 8 comprising encrypting the DNA based token to provide the encrypted DNA based token using a key calculated in response to the unique DNA information.

10. The method according to claim 7, wherein a participating in at least one authentication session of the multiple spaced apart authentication sessions comprises sending samples of biometric information related to the person, the biometric information is non-DNA information.

11. The method according to claim 1, comprising selecting non-DNA biometric information of the person to provide selected non-DNA biometric samples, wherein the selecting is responsive to the unique DNA information; wherein the selected non-DNA forms at least a portion of the authentication information.

12. The method according to claim 1 wherein the obtaining comprises:
extracting DNA information from at least one cell of the person; and
extracting the unique DNA information from the DNA information.

13. The method according to claim 1 wherein the obtaining comprises:
receiving DNA information that was extracted from at least one cell of the person; and
extracting the unique DNA information from the DNA information.

14. A non-transitory computer readable medium that stores instructions that once executed by a first computerized entity cause the first computerized entity to obtain unique DNA information of a person that is unique to the person; and participate in an authentication process for conforming an identity of the person, wherein the participating involves utilizing authentication information that is responsive to the unique DNA information.

15. A computerized device that comprises a memory module for storing unique Deoxyribonucleic acid (DNA) of a person; and a processor that is arranged to generate authentication information in response to the unique DNA information; and participate in an authentication process for conforming an identity of the person, wherein the participating involves utilizing the authentication information.
